(19) United States
(12) Patent Application Publication
(10) Pub. No.: US 2026/0307890 A1
(43) Pub. Date: Oct. 8, 2026

(54) TRANSPORT AND STORAGE SYSTEM FOR METAL COILS

(71) Applicant: VOESTALPINE STAHL GMBH, Linz (AT)

(72) Inventors: Martin KRASCHOWETZ, St. Georgen an der Gusen (AT); Martin PROMBERGER, Eggendorf im Traunkreis (AT); Philipp BACHINGER, Linz (AT); Georg REISINGER, Linz (AT)

(21) Appl. No.: 19/485,031

(22) PCT Filed: May 24, 2024
(86) PCT No.: PCT/EP2024/064396

§ 371 Date: Nov. 17, 2025

(30) Foreign Application Priority Data
May 24, 2023 (DE) 10 2023 113 576.7

(51) Int. Cl. B65D 85/66; B65D 85/671

(52) U.S. Cl. CPC B65D 85/66; B65D 85/671; B65D 2585/649

(57) ABSTRACT

The invention relates to a transport and storage system for metal coils for receiving, in particular horizontal, cylindrical metal sheet coils, wherein at least one module (12, 20) is present, which is formed from a stack of corrugated cardboard, wherein the liners (1, 4, 6) of the corrugated cardboard layers are oriented so that they extend substantially perpendicularly to a receiving surface (18, 24) of the module (12, 20), wherein the receiving surface (18) of the module (12) is embodied as flat or concave or extends in an elliptical curve and is embodied to produce a strip-like or full-surface contact with part of a circumferential wall (11) of a coil (8).

The invention relates to a transport system for metal coils, in particular sheet steel coils.

Steel or other metal sheets are usually produced in that a slab made of the corresponding metal material, which is usually produced by melting and casting the steel material into the slab mold, is then rolled into a flat sheet steel strip or flat sheet metal strip. For this purpose, a corresponding metal slab passes through a rolling mill with corresponding rolling stands, with the thickness of the slab and later of the sheet decreasing from one stand to the next.

Using sheet steel as an example, this takes place in such a way that the slab, which usually weighs between 20 and 40 tons, is first heated in a pusher furnace to ensure that the slab is at a very high temperature that permits deformation. This slab is then first pre-rolled in a reversing roughing stand and, after reaching a target thickness and while still in the hot and glowing state, is conducted through a hot rolling line with a large number of hot rolling stands.

The end result is a hot strip and the thickness of the hot strip can range from a few millimeters to a few centimeters.

In order to produce a thin sheet from this hot strip, this hot strip is then rolled to the target sheet thickness in a cold rolling mill; for thin sheet that is to be used in the automotive industry, for example, the target sheet thickness is between 0.3 and 1 mm.

Since the width of these strips is regulated, the change in thickness from the slab to the hot strip to the cold strip makes the continuous sheet metal strip very long so that at the end of the rolling process, it is wound into so-called bundles or coils in both the hot strip process and the cold strip process.

The thin sheet or cold-rolled strip can also be provided with coatings after the cold rolling; metallic coatings are usually applied using the hot-dip process, for example a hot-dip galvanized layer.

For this purpose, these strips are unwound again, conducted through a galvanizing unit, and then wound again.

At most, the weight of such steel coils can equal that of the slab, but multiple coils can also be produced from a single slab so that the weight of the wound coil is usually between 4 and 40 tons. The weight of the coil may also increase slightly after a potential coating process, in particular a galvanizing process.

In order to move such coils, specialized vehicles are used, which can reach with a mandrel through a longitudinal opening corresponding to the longitudinal axis of the cylindrical coil, lift the coil, and move it. Such a vehicle is known, for example, from WO2016044891. Such coils should therefore preferably be transported in a horizontal position since it is then possible to reach into the coil eye. In a vertical position, the coil eye would point upward and it would no longer be possible to perform such an action in the longitudinal axis of the coil.

During all stacking or transporting procedures, it is naturally important not to subject the steel coils to pressure at isolated points since this would deform the sheet metal or damage the metallic coating layer; as is known, such indentations can extend several layers into the interior of the coil. These regions therefore can no longer be classified as defect-free and in some cases must even be discarded.

Such coils can of course be transported by trucks, trains, or ships.

Due to the sensitivity of the coil surface or sheet metal surface on the one hand and on the other, the fact that these coils are very heavy and constitute a considerable potential hazard when they are put in motion, such coils must be transported in a way that is reliably safe, but also gentle. When transporting heavy loads, especially one-piece loads such as steel coils, particular attention must be paid to load distribution, i.e. point loading or excessive axle loads during transport can be problematic. Particular attention must be paid to this with regard to national and international freight transport regulations.

A number of approaches have already been tried for transporting coils, especially in containers.

It should be noted here that due to the considerable weight of steel coils, only one or at most two steel coils can ever be loaded per truck or per container and any movement of the steel coils must be prevented, especially in the case of sea-going containers, since a moving steel coil weighing 23 tons will permanently destroy any outer packaging.

EP 1 907 301 B1 discloses a stowage system in which metal coils are stored in polystyrene blocks, wherein the polystyrene block for receiving the steel coil corresponds to a recess that corresponds to the radius of the coil and receives a partial circumference of the coil, which is large enough that the steel coil cannot easily escape from this block. If multiple coils are present, a cuboid block is inserted as a spacer between the coils and between the first and last coil and a corresponding container wall. This is intended to secure the coils in the longitudinal and transverse directions.

IN 20 20 23 00 82 61 A1 discloses a comparable stowage system, which is, however, made of different materials, such as pressed paper.

AT 522 138 A1 discloses flexibly adapted support beams that extend through the polystyrene blocks as well as a central, continuous polystyrene support beam.

DE 10 2017 113 499 A1 discloses a transport protection for coils that is made of wood, wherein a thin layer of cardboard can be present between the wood and the coil to prevent indentations in the coil.

JP2022018234 A2 discloses a plug-in system made of cardboard that can be used to transport cylindrical bodies. This system cannot be used for steel coils, though, because the dimensions of the plug-in connections are too thin.

EP 1880899 A1 discloses a stowage system made of corrugated cardboard in which a simple, partially cylindrical support is formed from upright pieces of laminated corrugated cardboard, which are additionally provided with plastic layers. Such an arrangement is unable either to support steel coils or to hold them in place.

WO2009139643 A1 discloses a comparable system in which a corrugated cardboard is supported by an upright supporting structure that is likewise made of corrugated cardboard, with these upright supporting structures being connected by means of sleeves. Such an embodiment is unable to fulfill its function; it is far too unstable.

JP2019081614A2 also discloses a plug-in system comprised of plate-like elements for surrounding a coil with a ribbed structure made of corrugated cardboard. First of all, such a system is not particularly stable and also, it is almost impossible to use such a system in confined spaces.

The problem of the invention is to create a transport and storage system for metal coils, in particular steel coils, which reliably stores heavy metal coils or which can optimally ensure the load distribution in a transport and storage system and can be disposed of easily and without problems.

The problem is solved with a transport and storage system having the features of claim 1.

Advantageous modifications are disclosed in the dependent claims thereof.

The known systems in the prior art have some significant disadvantages: for one thing, the price of polystyrene blocks has risen significantly, for another, there are huge problems with disposal, or the polystyrene blocks have to be sent back, which adds to the costs in international shipping.

Particularly in the case of sustainably produced steel such as greentec steel®, it is also undesirable for sustainably produced steel to be delivered using non-sustainably produced transport systems.

Surprisingly, it has been discovered that the above-mentioned requirements can be met with a transport and storage system made of corrugated cardboard.

In this case, however, the corrugated cardboard is not, as is usually the case, employed with its broad side against the goods to be transported; instead, the orientation of the corrugated cardboard is basically selected so that the end surfaces, which extend transversely to the corrugation, are oriented toward the goods to be transported and/or stored-in this case, the coil.

Corrugated cardboard is a cellulose product made from the raw material paper. At least one smooth paper web and one fluted paper web are glued to each other to produce corrugated cardboard, it being both possible and common for there to be up to 7 of these. The decisive characteristic of a corrugated cardboard is the fluting. It gives the lightweight paper its strength through an intrinsically known increase in the so-called surface moment of inertia. In this connection, a distinction can be drawn between different flute types and flute combinations, which are more suitable depending on the requirements and the region in which they are used.

Corrugated cardboard is one of the most common packaging materials and is primarily used for transport packaging, i.e. folding cartons or telescoping boxes, for example. The advantage of corrugated cardboard is that it is light and stable. Thanks to the base material of paper, corrugated cardboard packaging can be easily and completely recycled, but can also very often be reused. It is now quite common to use so-called heavy-duty corrugated cardboard for cardboard packaging, which is affixed to a Euro pallet, for example, and can also hold heavy items such as car parts. With clever folding patterns, such heavy-duty corrugated cardboard boxes can be folded down to a fraction of their volume, returned, and reused multiple times.

The corrugated structure is the most important and decisive feature of corrugated cardboard and gives the latter its particular stability and strength. For example, the structure is such that there is a flat inner liner on which a first corrugated web is positioned, with an intermediate liner being positioned on the first corrugated web, followed by a second corrugated web, and after this, an outer liner. Such an arrangement results in a so-called double-flute structure, wherein the first corrugated web can have a different wave frequency than the second corrugated web, which further promotes stability. The advantage of the corrugation is, on the one hand, the considerable increase in stability, which three paper webs lying on top of each other would not have, by contrast with an arrangement having an inner liner, a corrugated web, and an outer liner.

As explained above, this is due to the increase in the surface moment of inertia. Since the corrugated web is glued to both the inner liner and outer liner in the region of the flute peaks, the corrugated web also cannot be displaced. The cavities formed in this way ensure that corrugated cardboard is very light in relation to its volume and also has an insulating effect. In the single-flute corrugated cardboard described above, the outer and inner liners are glued to the corrugated web. For multi-flute corrugated cardboards, an intermediate liner and an additional corrugated web are added.

Corrugated cardboard is produced in so-called corrugators. Paper webs are fed through corrugating rollers and embossed with the aid of heat, moisture, and pressure. The shape of the embossed flute resembles a sine wave in cross-section. The flute types differ by their flute pitch (t) and flute height (h). The distance between two flute valleys is the flute pitch (t). The distance between the flute valley and the flute peak is the flute height (h). In the single-flute range, the C flute (medium flute), B flute (fine flute), and E flute (ultra-fine flute or microflute) are among the most commonly used flute types. As mentioned above, the different flute types can also be different in the subsequent flutes of a multi-flute composite.

To give a corrugated cardboard greater stability, several layers are glued to one another. Typical flute combinations in the double-flute range are, for example, BC flute, EB flute, or EE flute. In triple-flute corrugated cardboard, ACA, BAA, EBC, or BBC are the flute combinations that are frequently used.

For the purposes of the invention, though, any other combination of the known flute types is also possible and intended.

Not only the flute combination but also the paper quality for the liner paper and the flute can be selected as a function of the load on the shipping packaging.

So-called kraft liner or test liner can be used for the liner paper, while so-called semichemical pulp or bogus paper can be used for the fluting.

Single-flute or double-flute corrugated cardboard is used for shipping lighter shipments. Triple-flute corrugated cardboard offers appropriate protection for heavy and sensitive goods and can be used as an alternative to wooden systems. Exports in particular are subject to a wide range of climatic conditions, which triple-flute corrugated cardboard usually withstands with no trouble. Surprisingly, it has turned out that in combination with adhesives, single-flute and especially double-flute corrugated cardboard can prove to be the most suitable solution for the application in terms of the combination of dead weight and load-bearing capacity. Single-flute or double-flute corrugated cardboard can therefore be advantageously used as a transport and storage material in the application according to the invention.

The quality of corrugated cardboard is checked using various testing systems. The DIN 55468 standard was developed based on the standards of the German Association of the Corrugated Board Industry. If corrugated cardboard solutions are to comply with the standard, the bursting strength, puncture resistance, and edge crush resistance, among other things, must comply with certain values.

In the transport and storage system according to the invention, corrugated cardboard is thus used in the manner according to the invention, wherein the corrugated web is built in perpendicular to the outer liner or inner liner or intermediate liner and in addition, is preferably built in in such a way that the fluting also extends transversely. In technical jargon, this is referred to as vertical flute corrugated cardboard. This is unusual in that normally, corrugated web is built in in such a way that the load rests on the inner or outer liner.

In addition, the invention provides for the corrugated cardboard to be combined to form corrugated cardboard stacks so that an at least double-flute composite or stack is formed. However, a triple-flute, in particular more than ten-flute, and even more preferably more than twenty-flute composite or stack can also be used. Surprisingly, however, it has turned out that a single-flute or double-flute corrugated cardboard composite can already have sufficiently high stability with a comparatively low dead weight.

According to the invention, the corrugated cardboard is also bonded with adhesives that are not susceptible to fungal attack and, in particular, with adhesives that do not provide a breeding ground for conventional fungi or other microbes, such as glues, in particular white glues, spray adhesives, or also hot-melt adhesives.

In addition, the paper forming the corrugated cardboard can also be embodied to be fungus-inhibiting.

Preferably, an adhesive is also used that does not dissolve when exposed to moisture. A 24-hour water bath test can be carried out for this purpose. In particular, the corrugated cardboard is glued or bonded in a waterproof manner.

In particular, the paper itself can also be embodied as moisture-resistant and in particular, can have a moisture-resistant bonding. This can also be omitted if a high-quality kraft liner is used.

Basically, the transport and storage system according to the invention can be used in two variants. In one embodiment, the corrugated cardboard forms a two-point or three-point support for a coil.

The transport and storage system is made up of one or more modules to form the two-point or three-point support.

In one embodiment, the transport system is composed of one module in which a region that is triangular in cross-section is cut out of a corrugated cardboard block. In this case, the opening of the triangular cut-out faces upward and is wider than the diameter of a coil.

In an embodiment with several modules, the first modules are embodied as triangles, in particular regular right triangles in which the triangle legs define a right angle between them. In this case, the corrugated cardboard is cut in such a way that the base of the triangle corresponds to the cross-section of the flutes or fluting.

These first modules support a coil on the triangular base so that the coil rests in linear fashion on each respective module. In this case, two modules are positioned opposite each other so that one leg rests on a floor and the other leg extends parallel to a side wall, for example of a container or other transport vessel. The spacing of the modules from one another can possibly be adjusted by means of second modules, which are inserted, for example, as flat modules between a container wall and the leg of the module extending parallel thereto. This means that the different thicknesses of the second modules can be used to establish the distance between the container wall and the triangle leg extending parallel thereto and thus the distance of the first modules from each other and thus the size of the opening for the coil that is formed by the two first modules.

If necessary, the vertexes pointing toward each other, which are formed by the base of the triangle and the leg resting on the ground, can be trimmed in order to establish an even smaller distance.

There can also be third modules that rest on the floor of a container, span the entire floor, and have the first and second modules resting on them. These can of course also be made of single-flute or multi-flute corrugated cardboard.

If the first modules have trimmed vertexes, a fourth module can also be positioned between the trimmed vertexes, which extends longitudinally between the two first modules, for example over the entire length of a coil, and preferably ends flush with the trimmed edge of the triangular base.

As described above, the bases of the respective first modules can thus rest against a coil in linear fashion, wherein both modules can extend over the full length of the coil or over a partial length of the coil. In addition, the coil can rest on the fourth module in linear fashion as a third support point so that the fourth module performs a load-bearing function on the one hand and on the other, performs a spacing function for the triangular first modules.

Instead of a continuous flat embodiment of the first modules, these modules can also extend only over a partial length of a coil and, for example, can be positioned one after the other in alternating fashion so that the modules alternate over the length of the coil and also rest against the coil in alternating fashion. In this embodiment, a fourth module can also be present, against which the first modules rest, but in the case of untrimmed vertexes, the modules can also be positioned so that they interlock with each other.

Preferably, the modules can extend in total over a length of more than 20%, in particular more than 30%, and especially preferably more than 40% of the coil width. Coil width in the sense of the invention is the size of the coil in the longitudinal axis of the coil eye.

If several coils are stowed in a container, then spacer elements made of corrugated cardboard can also be positioned in relation to the container end walls, e.g. the rear wall, extending over a full or partial width of the container. Such elements can naturally also be positioned between the coils and thus also in the longitudinal direction between the first, second, third, and fourth modules. This also secures the coils in the container in the longitudinal direction.

The contact regions of the first modules against the coil in this case should be selected in such a way that the coil is held securely and does not move from its position even when the container is moved; this is particularly the case if the contact regions are positioned above at least a quarter of the height of the horizontal coil, preferably a third of the height of the horizontal coil, in particular half the height of the horizontal coil.

In another embodiment of the invention, the first modules are embodied in the form of blocks, wherein a cylinder-sector circumferential wall is formed in the blocks, which is positioned and embodied to receive a part of the cylindrical circumferential wall of the coil over its entire surface.

For this purpose, a corresponding cut-out with the radius of the coil to be received is cut out from a single cuboid block of corrugated cardboard, for example.

The resulting recess opens toward the top.

In principle, the recess in a module can also be embodied as elliptical instead of having a curve that is strictly adapted to the radius of the coil. Although this does create a gap that opens toward the top, this gap can be filled with cardboard or anti-slip mats made of reusable rubber, for example. This advantageously permits slightly deviating coil diameters, in particular deviations of less than 10%, preferably less than 5% of the outer diameter, to be transported with the same module sizes.

In particular, if the receiving surface has an elliptical curvature, then the gap between the receiving surface and the circumferential wall of the coil can be filled with wedge-like fitting pieces or rubber mats that are adapted to the elliptical surface on the one side and to the coil radius on the other.

The depth of the cut-out is dimensioned in such a way that up to at least a quarter, in particular a third, and especially more than a third and up to half of the diameter or more than half of the diameter of a coil is supported in the cut-out.

In addition, it is also possible for a monolithic corrugated cardboard block not to extend across the entire width of the container and in this respect for the second modules described above to be used to establish the distance from the wall.

In another embodiment, the corrugated cardboard block is not monolithically constructed, but instead divided, particularly in the middle, so that at least two first modules are formed, each of which receives, for example, a quarter circumference or less of a coil.

In another embodiment, modules of the same shape are produced which, for example, receive a quarter circumference or less of a coil and are correspondingly positioned symmetrically opposite from one another on both sides of the coil. For example, three modules can be in-stalled on each side, which in total extend over at least 20%, preferably 40%, of the coil width. This advantageously permits a heavy weight of the metal coil to be securely held and the one-piece module design—i.e. the use of identical or similar modules, which are positioned around the coil symmetrically on both sides—can ensure an efficient manufacturing method and ease of handling.

With a coil diameter of, for example, 800 mm to 1800 mm, such blocks can, for example, have a height on the side that rests against the transport means wall of 600 mm to 1000 mm and can have a height of 15 to 20 mm on the side that receives the coil. The width of the modules can be selected between 1100 mm and 1245 mm so that they can be advantageously received in a standard container of around 2400 mm to 2500 mm and a gap of 10 mm to 100 mm still remains between the modules that are positioned around the coil on both sides. On the one hand, this can facilitate handling when inserting the modules and on the other hand, it can enable optimum force distribution across the floor of the transport means thus preventing the occurrence of load peaks at isolated points. The depth of the modules can vary depending on the requirements, but can advantageously be selected between 100 mm and 300 mm in order to facilitate handling and insertion into the transport means as well as to ensure sufficient stability.

It is also possible to position the first modules and an above-described third module so that they are spaced apart from one another, wherein the corresponding subregions for receiving a coil are then matched to one another and then in particular, amount to less than a quarter of the coil circumference to be received.

In this case, third modules resting on the floor can naturally also be provided.

In order to improve handling, the corrugated cardboard blocks can also be positioned in a subdivided way in relation to the length of a coil so that over the entire length of a coil, i.e. over the so-called coil width, there are, for example, three corresponding first modules per side, i.e. a total of six modules, positioned opposite from one another. Between these first modules, fifth modules can be provided, which space these first modules longitudinally apart from one another and fix them in position.

Tests have shown that a corrugated cardboard that is loaded in the above-described manner, namely on the end edges extending at right angles to the corrugation, exhibits such a high level of stability that it is not necessary to support the metal coil over its entire surface.

With first modules subdivided in this way—this also applies to the first embodiment—it is easy to comply with labor law regulations governing the maximum weight of blocks or weights that are to be manipulated by hand. This can advantageously enable manipulation by a single person. As described above, this can be enabled with a module depth of 100 mm to 300 mm, preferably 150 mm to 250 mm.

In one embodiment, the modules can be provided with chamber-like, hollow regions in order to further reduce the weight. Such hollow regions are preferably punched-out regions that are located underneath the actual receiving surface. There can also be multiple hollow regions that form a partition-like or truss-like supporting structure between them. This can further improve handling. In particular, this reduces the weight and thus takes occupational safety into account. In a particularly advantageous way, such a cut-out in the upper region of the module can be embodied in the form of carrying handles, which can facilitate handling and reduce weight.

Since clippings are produced when cutting out or punching out the corresponding recesses for a coil, these clippings, which ultimately have the shape of a pie slice, can also be easily inserted in the longitudinal direction and combined with one another to secure the load of the coils. In addition, such clippings can also be used as fifth modules for spacing apart the first modules.

In general, i.e. in all of the embodiments described thus far, the upper flank of the modules that rest against the container wall or transport means wall can also be provided with a recess into which a force-distributing element can be inserted in order to distribute any forces that occur into the container wall. This force-distributing element can be made of wood or corrugated cardboard, for example, and should preferably extend over the length of the entire container, particularly when several modules are used per coil side, in order to distribute any fluctuations during transport and thus any lateral forces that occur over the entire wall.

Since condensation often occurs in containers, it is advantageous if the corrugated cardboard is made of papers that can optionally be embodied as moisture-resistant. The same applies to the adhesive, which is preferably also waterproof.

To further protect the elements, a single layer of silicone paper or similar moisture-repellent material can be provided between the receiving surfaces of the modules on the one hand and the coil on the other.

One advantage of the invention is that, surprisingly, corrugated cardboard, when loaded on its end surfaces contrary to its conventional use, has a surprisingly high stability, which is sufficient for use in a transport and storage system. Another advantage is that a sustainable stowage system is used, which can be reused multiple times if necessary, but can also be easily recycled at the end of its use cycle and can therefore be used endlessly. Even thermal recycling is possible since it involves a renewable raw material.

The invention thus relates in particular to a transport and storage system for metal coils for receiving cylindrical sheet metal coils, in particular horizontally oriented ones, wherein at least one module is present, which is formed from a stack of corrugated cardboard, wherein the liners of the corrugated cardboard layers are oriented so that they extend substantially perpendicularly to a receiving surface of the module, characterized in that the receiving surface of the module is embodied as flat or concave or extends in an elliptical curve and is embodied to produce a strip-like or full-surface contact with part of a circumferential wall of a coil.

In one modification, the module or modules extend(s) in total over a length of more than 20%, in particular more than 30%, and especially preferably more than 40% of the coil width.

In one modification, similarly shaped modules are positioned symmetrically opposite from one another on both sides of the coil in relation to a vertical plane extending through the longitudinal axis of the coil. This can simplify the manufacture of the modules and reduce the operating weight without jeopardizing the stability of the transport.

In one modification, the receiving surface of one or more modules and possibly an additional module form(s) a two-or three-point support for a coil.

In one modification, the module has a cut-out region that is triangular region in cross-section, wherein the opening of the triangular cut-out faces upward and is wider than a coil diameter.

In one modification, at least two modules are formed, which are embodied as triangles in cross-section and in particular are regular right triangles in which the triangle legs define a right angle to each other.

In one modification, the modules are embodied as triangular in cross-section and each extend only over part of the length of the coil and are positioned with their receiving surfaces offset from each other so that broad sides partially rest against one another.

In one modification, the vertexes of the triangular modules are respectively cut off and the opposing triangular modules are thus positioned with vertical surfaces abutting each other.

In one modification, in cross-section, modules are embodied as regular right triangles in which the triangle legs define a right angle to each other.

In one modification, at least one cylindrical element extends away from a receiving surface, toward an outer surface, and through the module and/or adjacent modules.

In one modification, the at least one cylindrical element is mounted in a bore with a positive fit or interference fit

In one modification, the bore extends radially outward in relation to the radius of a receiving surface or extends outward at an angle to the radial direction.

In one modification, the cylindrical element is embodied as a solid cylinder or hollow cylinder.

In one modification, the cylindrical element is made of metal, plastic, or cardboard.

In one modification, the cylindrical element extends through the bore and terminates with a positive fit with the respective surfaces of the module or modules, or the cylindrical element is recessed by 1 mm to 100 mm, in particular 2 to 50 mm, preferably 2 to 20 mm, in the region of the receiving surface and spaced apart by means of a cavity.

In one modification, the cylindrical element contacts a bottom wall of a container or a load-bearing beam of an entire transport arrangement. This allows the force of the coil that is to be supported to be advantageously transferred to the floor or the load-bearing beams of the entire transport device.

In one modification, several bores and several cylindrical elements distributed around the circumference of the receiving surface extend through the module or modules.

In one modification, the receiving surface of the module is flat so that the contact surface corresponds to a strip.

In one modification, the corrugated cardboard for forming the modules, or the stacks of corrugated cardboard, or the corrugated cardboard and the stacks formed therefrom are glued together in a waterproof manner.

In one modification, the material for the liners of the corrugated cardboard is a kraft liner.

In one modification, the corrugated webs are made of semichemical pulp or bogus paper.

In one modification, the module has at least one hollow region. The hollow design enables weight optimization while still ensuring sufficient stability and force absorption.

In one modification, the module has multiple hollow regions that form a web-like or truss-like supporting structure between them.

In one modification, the liners and the corrugated layers are glued in a moisture-resistant and in particular waterproof manner.

In one modification, the corrugated cardboard layers are combined to form corrugated cardboard stacks that are glued together over their entire surface by means of the liners so that an at least double-flute, in particular triple-flute, preferably more than ten-flute, and even more preferably more than twenty-flute composite or stack is formed.

In one modification, the material forming the corrugated cardboard is equipped or bonded in a way that makes it moisture-resistant and/or fungicidal.

In one modification, two modules are positioned opposite each other so that one leg rests on a floor and a vertical leg, which forms a right angle with the leg, extends away from the floor.

In one modification, in order to adjust the spacing between the modules and in particular the spacing relative to a container wall, narrow cuboid modules are positioned between the leg and a container wall.

In one modification, the modules are embodied as triangular in cross-section and each extend over only part of the length of the coil and are positioned with their receiving surfaces offset from each other so that broad sides partially rest against one another.

In one modification, the vertexes of the triangular modules are respectively cut off and the opposing triangular modules are thus positioned with vertical surfaces abutting each other.

In one modification, in cross-section, the modules are in particular regular, right triangles in which the legs define a right angle.

In one modification, the modules are braced directly or indirectly against a container wall with a first flat, upright leg and the module stands directly or indirectly on a container floor with a leg extending at right angles thereto, wherein the base of the triangular module is embodied with the concave or elliptically curved cylinder-segment-shaped receiving surface, which is embodied to rest against a circumferential wall of a coil, wherein the radius of the concave, curved receiving surface corresponds to the outer radius of a coil, or the elliptical curvature deviates from the outer radius of a coil by a maximum of 100 mm, in particular by a maximum of 50 mm.

In one modification, in the case of an elliptical curvature of the receiving surface, the gap between the receiving surface and the coil circumferential wall is filled with wedge-like fitting pieces or reusable rubber elements, such as anti-slip mats, that are adapted to the elliptical surface on the one side and to the coil radius on the other.

In one modification, the modules are spaced apart from one another in the region of the longitudinal center of the coil, in particular by 1 mm to 100 mm, preferably 5 mm to 50 mm, wherein each receiving surface supports a partial circumference of the circumferential wall of the coil and the height of the modules is selected so that more than one third and in particular more than half of the coil diameter is supported.

In one modification, pieces cut out of modules are positioned for securing the load and spacing the modules or coils apart from one another.

In one modification, a corrugated cardboard module, which preferably reaches from one container wall to the opposite container wall, is positioned between a container floor and a leg extending parallel to the floor.

Another aspect of the invention relates to the use of corrugated cardboard that is glued in a waterproof manner in transport and storage systems for metal sheet coils.

Another aspect of the invention relates to the use of anti-fungal or bactericidal corrugated cardboard in transport and storage systems for sheet metal coils.

Another aspect of the invention relates to the use of waterproof and/or anti-fungal adhesives for corrugated cardboards in transport and storage systems for metal coils

Yet another aspect of the invention relates to the use of silicone paper as an intermediate layer between the modules and a coil to be stored thereon and as a cover for the areas not covered by a coil.

The invention will be explained by way of example in conjunction with the drawings. In the drawings:

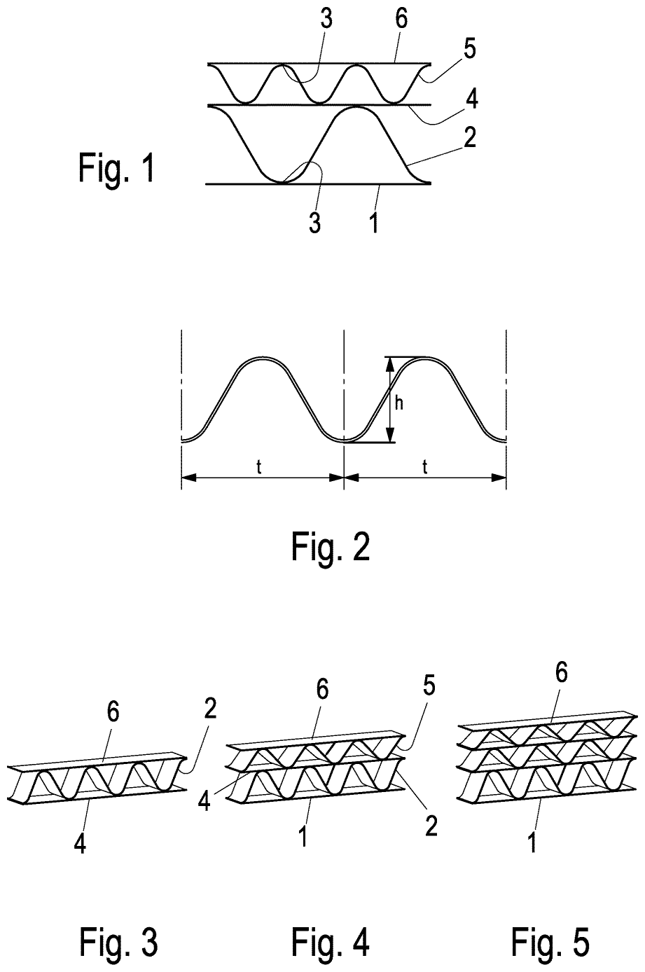

FIG. 1: shows the basic structure of a double-flute corrugated cardboard;

FIG. 2: shows a flute with the dimensions;

FIG. 3: shows a single-flute corrugated cardboard;

FIG. 4: shows a double-flute corrugated cardboard;

FIG. 5: shows a triple-flute corrugated cardboard;

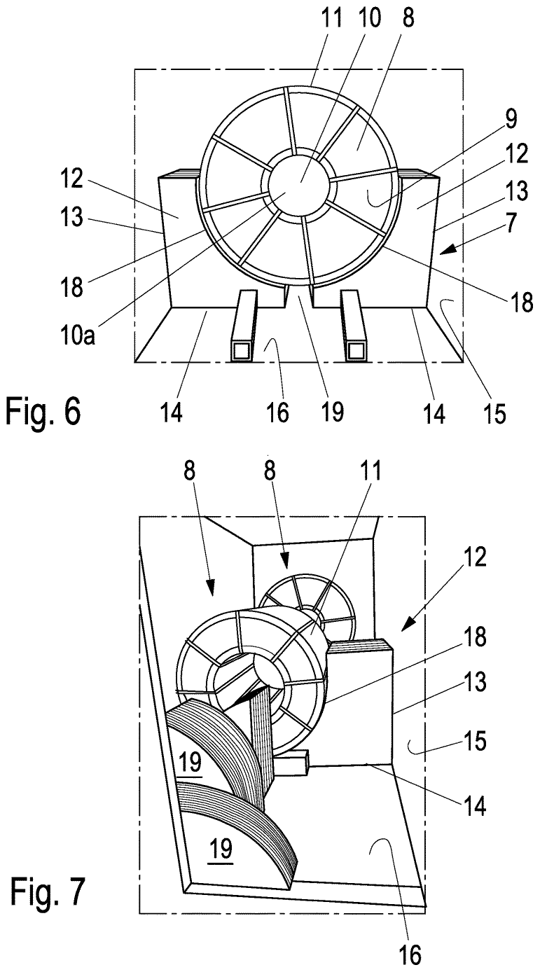

FIG. 6: shows a coil in a transport and storage system according to the invention;

FIG. 7: shows cut-out pieces for securing the load;

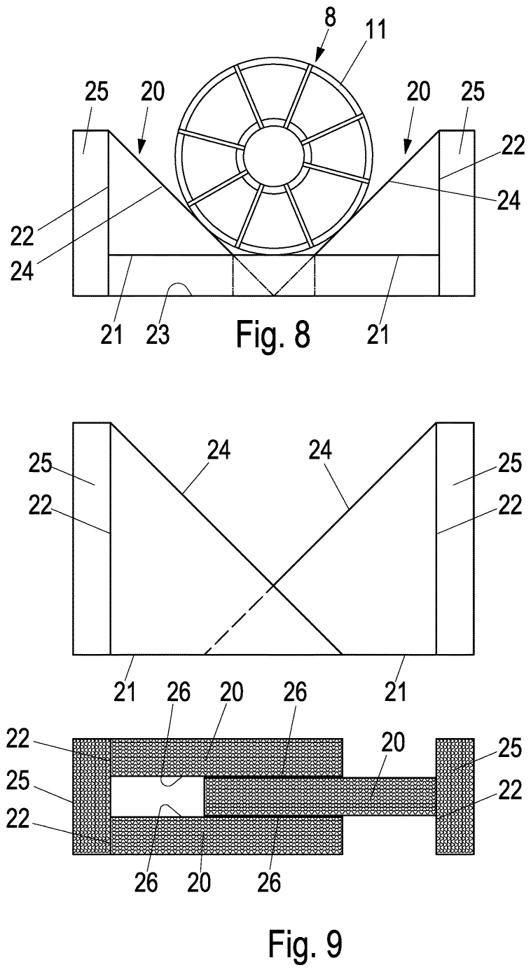

FIG. 8: shows a transport and storage system with triangular modules;

FIG. 9: shows triangular modules that are positioned offset from one another;

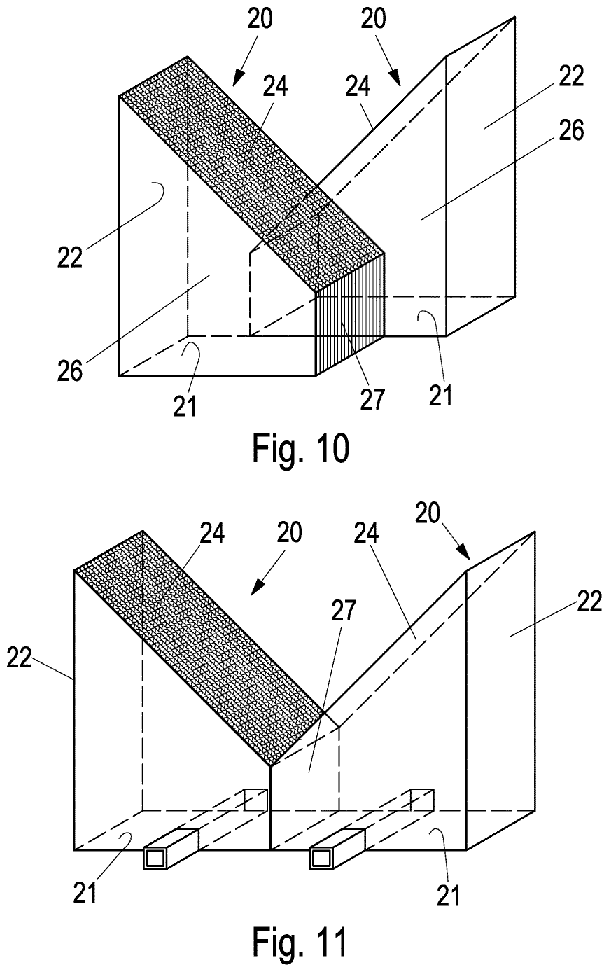

FIG. 10 shows another embodiment of the triangular modules;

FIG. 11 shows triangular modules with cut-off vertexes and inserted longitudinal rails.

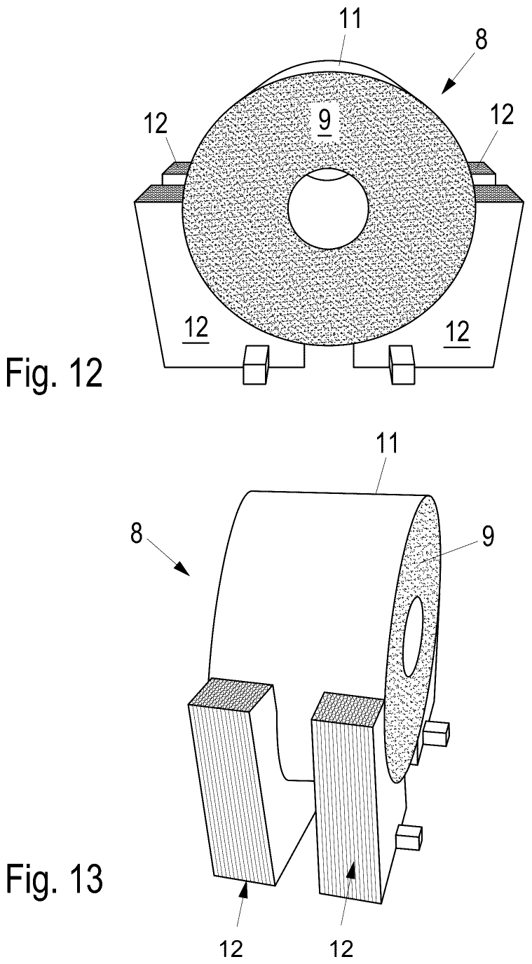

FIG. 12 shows an embodiment with modules that have cut-outs for cylindrical circumferential walls;

FIG. 13 shows a side view of the modules according to FIG. 12;

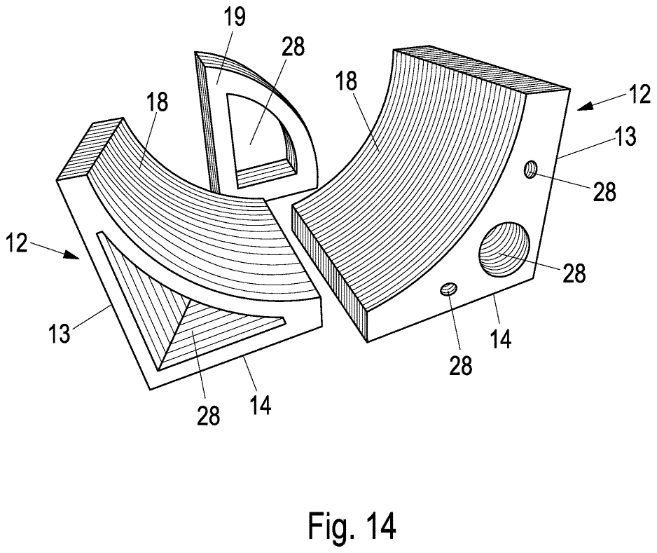

FIG. 14 shows the modules with hollow, chamber-like regions in the unloaded state

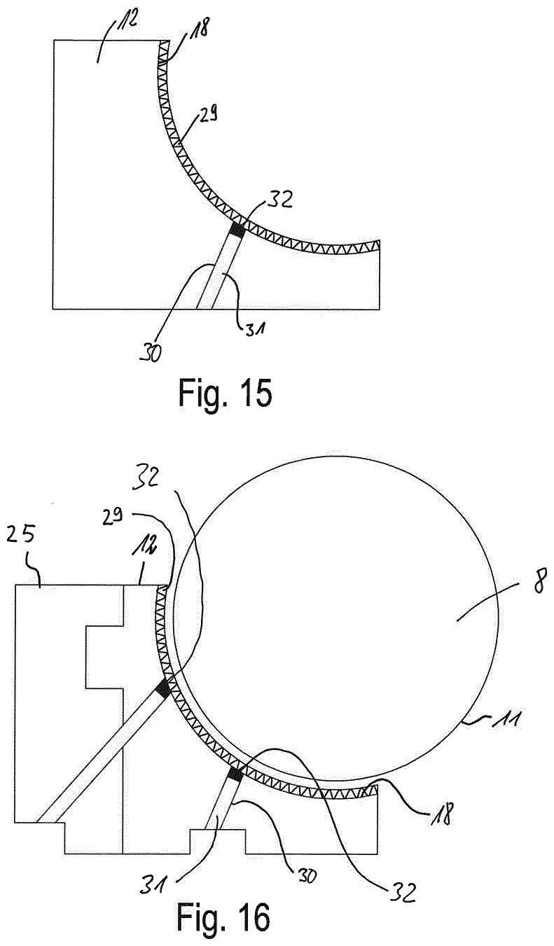

FIG. 15 shows the modules with a reinforcing element;

FIG. 16 shows another embodiment of a module with reinforcing elements.

FIG. 1 shows the basic structure of a double-flute corrugated cardboard. An inner liner 1, which is a flat paper layer, is followed by a first corrugated web 2, which rests with its flute peaks 3 against the inner liner 1 and is glued to it.

This corrugated web 2 has an intermediate liner 4, which is also a flat paper surface, resting against it and this intermediate liner 4 has another corrugated web 5 resting against it, which has a lower height and whose distance (t) between flute peaks 3 is also smaller. An outer liner 6, which is also a flat paper web, is glued to this corrugated web 5, resting against the flute peaks 3.

The papers used for this are known thick, tear-resistant papers, in particular so-called kraft liner paper, at least on the outsides for additional stability and moisture protection.

The individual sheets, such as the inner liner 1, the intermediate liner 4, and the outer liner 6, are correspondingly bonded to the corrugated webs 2, 5 in a waterproof manner.

According to the invention, it has turned out that pure cornstarch adhesives are unsuitable for the use of corrugated cardboard according to the invention since they are unable to withstand climatic conditions, in particular moisture, and can also be a breeding ground for fungi. If resin is added to the corn starch adhesive, this can greatly increase the resistance to moisture and fungal attack.

FIG. 2 shows a corrugated web with a view of the end surface in which the flute pitch (t) and the flute height (h) are indicated. The distance between two flute peaks is the flute pitch (t) and the distance between a flute valley and the next flute peak is the flute height (h).

In principle, single-flute, double-flute, or multi-flute corrugated cardboards can be used since according to the invention, stacks of several layers of corrugated cardboard are created anyway, which are glued together over their entire surface.

Typical flute combinations in the double-flute range according to the standard are BC flute, EB flute, or EE flute. In triple-flute corrugated cardboards, ACA, BAA, EBC, or BBC flute combinations are common. However, depending on requirements, any desired combination of the known flute types K flute, A flute, C flute, B flute, D flute, E flute, F flute, G flute, and N flute is possible.

Kraft liner is used as the liner material. Semichemical pulp or bogus paper is selected for the corrugation, with various combinations being possible here.

Depending on the climatic conditions, these papers can also be equipped in a way that makes them moisture-resistant, biocidal, or fungicidal. In particular, they can be embodied to be fungicidal.

FIGS. 3, 4, and 5 basically show the single-flute, double-flute, and triple-flute structures once again.

According to the invention, block-like modules are formed from stacks of corrugated cardboard. Thus, combinations of triple-flute, double-flute and single-flute corrugated cardboard are possible and desired and in particular, can be used to establish the exact width of the individual modules. In this case, the corresponding single-flute, double-flute, or triple-flute cardboards are placed with their outer liners resting against one another and are glued to one another so that, in addition to the usual corrugated cardboard bonding in the single-flute, double-flute, or triple-flute structure, additional corrugated cardboards are glued to one another over their entire surface.

The adhesives used for corrugated cardboard production can be used in this case as well and particularly in this connection, correspondingly climate-resistant, moisture-resistant, and heat-resistant adhesives can be used. In particular, mixtures of cornstarch, glue with synthetic resins, and starch adhesives can be used for wet-strength bonding of the individual webs.

FIG. 6 shows a transport and storage system 7. A cylindrical coil 8 is shown here, which can be seen from the end surface 9 and has a central, hollow cylindrical opening 10a surrounding the longitudinal axis 10. This coil 8 has a circumferential wall 11. Modules 12 are positioned so that they rest against the circumferential wall 11.

In relation to the legs 13, 14, the modules 12 are in particular regular right triangles in which the legs 13 and 14 define a right angle.

The modules 12 are supported by a first flat, upright leg 13 against a container wall 15. With a leg 14 extending at right angles thereto, the module 12 stands on a container floor 16.

In one embodiment (FIGS. 6 & 7), the base of the triangular module 12 is embodied with a concavely curved, cylindrical-segment-shaped receiving surface 18, which rests against the circumferential wall 11 of the coil 8 and is embodied to preferably rest against the entire surface of the circumferential wall 11 of the coil 8. In particular, the radius of the concave curved receiving surface 18 refers to the outer radius of the coil 8.

These modules 12 are spaced apart from each other in the region of the longitudinal center 19 of the coil 8, wherein each receiving surface 18 supports a partial circumference of the circumferential wall 11 of the coil 8 and the height H of the modules 12 is selected so that more than half of the coil diameter is supported.

FIG. 7 shows the leftover pieces 19 that have been cut out from the modules 12 and have been placed in front of the end surface 9 of the coil 8 to secure the load and space it apart from another coil 8.

FIG. 8 shows an embodiment in which the modules 20 that are triangular in cross-section are used, wherein the triangular modules 20 rest with one leg 21 on the floor and extend away from the floor 23 with a vertical leg 22 that defines a right angle with the leg 21.

In this case, a corresponding coil 8 rests with parts of the circumferential wall 11 in strip-like fashion against the receiving surface 24 that connects the legs 21, 22. In order to adjust the spacing between the two modules 20 and in particular, the spacing relative to a container wall 15, narrow cuboid modules 25 are positioned between the leg 22 and a container wall 15.

FIG. 9 shows this once again in schematic form, where here, it is clear that the modules 20 are embodied as triangular in cross-section and each extend over only part of the length of the coil 8 and are positioned with their receiving surfaces 24 offset from each other so that broad sides 26 partially rest against one another.

Here, too, modules 25 are provided in order to adjust the lateral spacing.

FIG. 10 shows this once again in schematic form in a perspective view, where here, it is clear how these modules 20 can be slid relative to each other in order to set a particular width that is matched to a coil diameter.

FIG. 11 shows another embodiment in which the vertexes of the triangular modules 20 are respectively cut off and the two triangular modules 20 are thus positioned with their vertical surfaces 27 abutting each other. In this case, the modules 20 are flush with each other in the longitudinal direction of the coil 8 and are not positioned offset from each other.

FIG. 12 once again shows the embodiment from FIG. 6, but in this instance, the modular design is clearly visible, where in this case, four modules 12 are provided in the system for supporting the coil 8.

FIG. 13 shows a side view of the depiction from FIG. 12.

In FIG. 14, the modules 12 are shown in the unloaded state and a cut-out part is shown in the background. These modules 12 are embodied with chamber-like hollow regions 28. Such hollow regions 28 are preferably punched-out regions that are located beneath the actual receiving surface 18. There can also be multiple hollow regions 28 that form a web-like or truss-like supporting structure between them. This makes it possible to further reduce the weight without jeopardizing the stability and load-bearing capacity. To achieve this, the punched-out pieces can be adapted to follow the outer contour as shown on the left side or can have holes or other circular shapes as shown on the right side.

FIGS. 15 and 16 show other embodiments in which a further stabilization of the corrugated cardboard is provided.

FIG. 15 shows a very schematic section through a corrugated cardboard module 12, 20 according to the invention. For example but not necessarily, a layer of corrugated cardboard is provided on a receiving surface 18, 24 and can function as a softer damping layer 29. Underneath the damping layer 29, a bore 30 extends through the module 12, 20. The bore 30 here can be oriented radially outward in relation to the radius of the receiving surface 18, 24 or can extend outward at an angle to the radial direction. In this instance, the bore 30 extends all the way through the module 12, 20.

Preferably, a cylindrical or hollow-cylindrical element 31 such as a pipe or sleeve is mounted in the bore 30.

The element 31 can be made of metal, plastic, or cardboard. Preferably, the element 31 is mounted in the bore 30 with a positive fit or a slight interference fit.

The element 31 can extend all the way through the bore 30 and can also terminate in a form-fitting way relative to the respective surface of the module 12, 20. In the region of the receiving surface 18, 24, however, the element 31 can also be recessed slightly and spaced apart from the receiving surface 18, 24 by means of a cavity 32 in order to maintain a safety distance so as not to dent a coil 8 in the event of deformations of the module 12, 20.

The element 31 here can also extend through several modules 12, 20 and for example a lateral spacing module 25 (FIG. 16), thereby connecting them and transferring the force into both modules 12, 20, 25, and from there to a bottom wall of a container or a load-bearing beam of an entire transport arrangement. This can further improve the introduction of the forces of the coil 8 into the floor 16 of the transport arrangement and can ensure a corresponding distribution of forces and in particular can avoid a point loading or excessive axle loads.

In this connection, several bores 30 and several elements 31 can also be distributed around the circumference of the receiving surface 18, 24.

In particular, when the element 31 is embodied of cardboard or in the form of a cardboard sleeve, the advantage is that the transport concept is composed of a single material that is also recyclable.

In order to achieve even greater protection from the effects of moisture in more extreme climatic conditions, especially in tropical regions, the end surfaces of the corrugated cardboard that are open due to the corresponding cuts can also be covered with kraft liner paper or, in extreme cases, with silicone paper or similar water-repellent layers.

One advantage of the invention is that a sustainable raw material is used to produce load-bearing transport and storage systems 7 that have a high load-bearing capacity and are gentle to the stored goods.

1. A transport and storage system (7) for metal coils (8) for receiving cylindrical sheet metal coils, in particular horizontally oriented ones, wherein at least one module (12, 20) is present, which is formed from a stack of corrugated cardboard, wherein the liners (1, 4, 6) of the corrugated cardboard layers are oriented so that they extend substantially perpendicularly to a receiving surface (18, 24) of the module (12, 20), characterized in that the receiving surface (18) of the module (12) is embodied as flat or concave or extends in an elliptical curve and is embodied to produce a strip-like or full-surface contact with part of a circumferential wall (11) of a coil (8).

2. The transport and storage system (7) according to claim 1, characterized in that the module (12, 20) or modules (12, 20) is/are embodied to extend in total over a length of more than 20%, in particular more than 30%, especially preferably more than 40% of the coil width and/or that similarly shaped modules (12, 20) are positioned symmetrically opposite from one another on both sides of the coil (8) with respect to a vertical plane extending through the longitudinal axis of the coil (8).

3. (canceled)

4. The transport and storage system (7) according to claim 1, characterized in that the receiving surface (24) of one or more modules (20) and possibly an additional module form(s) a two-or three-point support for a coil, wherein the module 20 has a cut-out region that is triangular region in cross-section, wherein the opening of the triangular cut-out faces upward and is wider than a coil diameter and/or at least two modules (20) are formed, which are embodied as triangles in cross-section and in particular are regular right triangles in which the triangle legs (21, 22) define a right angle to each other and that the modules (12, 20) are embodied as triangular in cross-section and each extend only over part of the length of the coil (8) and are positioned with their receiving surfaces (24) offset from each other so that broad sides (26) partially rest against one another.

5-7. (canceled)

8. The transport and storage system (7) according to claim 1, characterized in that the vertexes of the triangular modules (20) are respectively cut off and the opposing triangular modules (20) are thus positioned with vertical surfaces (27) abutting each other.

9. The transport and storage system (7) according to claim 1, characterized in that in cross-section, modules (12) are embodied as regular right triangles in which the legs (13, 14) define a right angle to each other.

10. The transport and storage system (7) according to claim 1, characterized in that at least one cylindrical element (31) extends away from a receiving surface (18, 24), toward an outer surface, and through the module (12, 20, 25) and/or adjacent modules (12, 20, 25), wherein the at least one cylindrical element (31) is mounted in a bore (30) with a positive fit or interference fit, wherein the bore (30) extends radially outward in relation to the radius of a receiving surface (18, 24) or extends outward at an angle to the radial direction and the cylindrical element (31) is embodied as a solid cylinder or hollow cylinder made of metal, plastic, or cardboard.

11-14. (canceled)

15. The transport and storage system (7) according to claim 1, characterized in that the cylindrical element (31) extends through the bore (30) and terminates with a positive fit with the respective surfaces of the module (12, 20) or modules (12, 20, 25), or the cylindrical element (31) is recessed by 1 mm to 100 mm, in particular 2 mm to 50 mm, preferably 2 mm to 20 mm, in the region of the receiving surface (18,

24) and spaced apart from the receiving surface (18, 24) by means of a cavity (32).

16. The transport and storage system (7) according to claim 1, characterized in that the cylindrical element (31) contacts a bottom wall of a container or a load-bearing beam or rail of an entire transport arrangement.

17. The transport and storage system (7) according to claim 1, characterized in that several bores (30) and several cylindrical elements (31) distributed around the circumference of the receiving surface (18, 24) extend through the module (12, 20) and/or modules (12, 20, 25).

18. The transport and storage system (7) according to claim 1, characterized in that the corrugated cardboard for forming the modules (12, 20), or the stacks of corrugated cardboard, or the corrugated cardboard and the stacks formed therefrom are glued together in a waterproof manner.

19. The transport and storage system (7) according to claim 1, characterized in that the material for the liners (1, 4, 6) of the corrugated cardboard is a kraft liner and/or the corrugated webs (2, 5) are made of semichemical pulp or bogus paper.

20. The transport and storage system (7) according to claim 1, characterized in that the module (12, 20) has at least one hollow, chamber-like region (28).

21. The transport and storage system (7) according to claim 1, characterized in that the module (12, 20) has multiple hollow regions (28) that form a web-like or truss-like supporting structure between them.

22. The transport and storage system (7) according to claim 1, characterized in that the liners (1, 4, 6) and the corrugated layers (2, 5) are glued in a moisture-resistant and in particular waterproof manner and/or the paper material forming the corrugated cardboard is equipped or bonded in a way that makes it moisture-resistant and/or fungicidal.

23. The transport and storage system (7) according to claim 1, characterized in that the corrugated cardboard layers are combined to form corrugated cardboard stacks which are glued together over their entire surface by means of the liners (1, 3, 6) so that an at least two-flute, in particular more than three-flute, preferably more than ten-flute, and even more preferably more than twenty-flute composite or stack is formed.

24. (canceled)

25. The transport and storage system (7) according to claim 1, characterized in that in order to adjust the spacing between the modules (12, 20) and in particular the spacing relative to a container wall (15), narrow cuboid modules (25) are positioned between the leg (22) and a container wall (15).

26-27. (canceled)

28. The transport and storage system (7) according to claim 1, characterized in that the modules (12) are braced directly or indirectly against a container wall (15) with a first flat, upright leg (13) and the module (12) stands directly or indirectly on a container floor (16) with a leg (14) extending at right angles thereto, wherein the base of the triangular module (12) is embodied with the concave or elliptically curved cylinder-segment-shaped receiving surface (18), which is embodied to rest against a circumferential wall (11) of a coil (8), wherein the radius of the concave, curved receiving surface (18) corresponds to the outer radius of a coil (8), or the elliptical curvature of the receiving surface (18) deviates by at most 50 mm, in particular at most 10 mm, from the outer radius of the coil (8).

29. The transport and storage system (7) according to claim 1, characterized in that, in the case of an elliptical curvature of the receiving surface (18), the gap between the receiving surface (18) and the coil circumferential wall (11) is filled with wedge-like fitting pieces or reusable rubber elements, in particular anti-slip mats, that are adapted to the elliptical surface on the one side and to the coil radius on the other.

30. The transport and storage system (7) according to claim 1, characterized in that the modules (12) are spaced apart from one another in the region of the longitudinal center (19) of the coil (8), in particular spaced apart by 1 mm to 100 mm, preferably 5 mm to 50 mm, wherein each receiving surface (18) supports a partial circumference of the circumferential wall (11) of the coil (8) and the height (H) of the modules (12) is selected so that more than one third and in particular more than half of the coil diameter is supported.

31. (canceled)

32. The transport and storage system (7) according to claim 1, for rail, truck, or maritime transport or for the storage of metal coils in buildings.
